(19) United States
(12) Patent Application Publication
(10) Pub. No.: US 2025/0010894 A1
(43) Pub. Date: Jan. 9, 2025

(54) CURVED/STRAIGHT GUIDE DEVICE

(71) Applicant: NIPPON THOMPSON CO., LTD., Tokyo (JP)

(72) Inventor: Satoshi SASAKI, Mino-shi (JP)

(73) Assignee: NIPPON THOMPSON CO., LTD., Tokyo (JP)

(21) Appl. No.: 18/712,508

(22) PCT Filed: Nov. 9, 2022
(86) PCT No.: PCT/JP2022/041665

§ 371 Date: May 22, 2024

(30) Foreign Application Priority Data
Nov. 26, 2021 (JP) 2021-191741

(51) Int. Cl. B61F 5/44

(52) U.S. Cl. CPC B61F 5/44

(57) ABSTRACT

A straight-curved guide device including a rail and a movable element. The movable element includes a frame and first and a second swing portions. The swing portions are configured to be pivotable about connecting portions to the frame. Each swing portion includes an arm portion and first and second bearing portions. The first bearing portion includes first and second track members, and a plurality of first rolling elements. The second bearing portion includes third and fourth track members, and a plurality of second rolling elements. The straight-curved guide device further includes an elastic member, which is arranged across a space between the arm portions of the swing portions and is in a compressed state in which the elastic member is compressed in a longitudinal direction of the rail or a stretched state in which the elastic member is stretched in the longitudinal direction of the rail.

### TECHNICAL FIELD

The present disclosure relates to a straight-curved guide device. This application claims priority from Japanese Patent Application No. 2021-191741, filed on Nov. 26, 2021, the contents of which are incorporated herein by reference in their entirety.

### BACKGROUND ART

Hitherto, there has been known a straight-curved guide device in which a movable element travels on a rail including a straight part and a curved part. This kind of technology is disclosed in, for example, Patent Literature 1.

The movable element of the straight-curved guide device disclosed in Patent Literature 1 includes a pair of rollers that are arranged apart from each other in a width direction of the rail. A rail groove is formed in an outer peripheral surface of each of the rollers. The movable element is moved on the rail in a longitudinal direction while ends of the rail in the width direction are being in contact with the rail grooves.

### CITATION LIST

### Patent Literature

[PTL 1] JP 6-39672 A

### SUMMARY OF INVENTION

### Technical Problem

In the straight-curved guide device disclosed in Patent Literature 1, a gap between the roller and the rail may be increased due to a difference in accuracy of a width dimension of the rail while the movable element is being moved. Thus, a related-art straight-curved guide device has a problem in that guiding accuracy may decrease as a result of an increase in the gap between the roller and the rail.

An object of the present disclosure is to provide a straight-curved guide device that enables suppression of a decrease in guiding accuracy.

### Solution to Problem

A straight-curved guide device according to the present disclosure includes: a rail including a straight part and a curved part; and a movable element being movable on the rail. The movable element includes: a frame; a first swing portion, which is connected to the frame and is in contact with the rail; and a second swing portion, which is connected to the frame in such a manner as to be spaced apart from the first swing portion in a longitudinal direction of the rail and is in contact with the rail. The first swing portion and the second portion are configured to be pivotable about connecting portions to the frame in a plane including the longitudinal direction of the rail and a width direction of the rail. Each of the first swing portion and the second swing portion includes: an arm portion extending in the width direction of the rail; a first bearing portion arranged on one side of the arm portion when viewed from a center of the arm portion in a longitudinal direction of the arm portion; and a second bearing portion arranged on another side of the arm portion when viewed from the center of the arm portion in the longitudinal direction of the arm portion. The first bearing portion includes a first track member, a second track member, and a plurality of first rolling elements. The first track member passes through the arm portion in a height direction of the rail, has an outer peripheral surface including a first raceway surface having a circular annular shape, and is fixed to the arm portion. The second track member has an inner peripheral surface including a second raceway surface having a circular annular shape being opposed to the first raceway surface, and has an outer peripheral surface including a first rail groove having a circular annular shape being in contact with the rail. The first rolling elements are arranged in a first rolling passage having a circular annular shape defined by the first raceway surface and the second raceway surface. The second bearing portion includes a third track member, a fourth track member, and a plurality of second rolling elements. The third track member passes through the arm portion in the height direction of the rail, has an outer peripheral surface including a third raceway surface having a circular annular shape, and is fixed to the arm portion. The fourth track member has an inner peripheral surface including a fourth raceway surface having a circular annular shape being opposed to the third raceway surface, and has an outer peripheral surface including a second rail groove having a circular annular shape being in contact with the rail. The second rolling elements are arranged in a second rolling passage having a circular annular shape defined by the third raceway surface and the fourth raceway surface. The straight-curved guide device further includes an elastic member, which is arranged across a space between the arm portion of the first swing portion and the arm portion of the second swing portion and is in a compressed state in which the elastic member is compressed in the longitudinal direction of the rail or in a stretched state in which the elastic member is stretched in the longitudinal direction of the rail.

### Advantageous Effects of Invention

According to the present disclosure, the straight-curved guide device that enables suppression of a decrease in guiding accuracy can be provided.

### BRIEF DESCRIPTION OF DRAWINGS

FIG. 1 is a perspective view for illustrating a configuration of a straight-curved guide device according to a first embodiment.

FIG. 2 is a front view for illustrating a configuration of a movable element of the straight-curved guide device according to the first embodiment.

FIG. 3 is a side view for illustrating the configuration of the straight-curved guide device according to the first embodiment.

FIG. 4 is a sectional view taken along the line IV-IV of FIG. 2.

FIG. 5 is a sectional view of a first swing portion in the first embodiment, taken in a height direction.

FIG. 6 is an explanatory sectional view for illustrating a configuration of a straight-curved guide device according to a third embodiment.

### DESCRIPTION OF EMBODIMENTS

### Outline of Embodiments

A straight-curved guide device according to the present disclosure includes: a rail including a straight part and a curved part; and a movable element being movable on the rail. The movable element includes: a frame; a first swing portion, which is connected to the frame and is in contact with the rail; and a second swing portion, which is connected to the frame in such a manner as to be spaced apart from the first swing portion in a longitudinal direction of the rail and is in contact with the rail. The first swing portion and the second portion are configured to be pivotable about connecting portions to the frame in a plane including the longitudinal direction of the rail and a width direction of the rail. Each of the first swing portion and the second swing portion includes: an arm portion extending in the width direction of the rail; a first bearing portion arranged on one side of the arm portion when viewed from a center of the arm portion in a longitudinal direction of the arm portion; and a second bearing portion arranged on another side of the arm portion when viewed from the center of the arm portion in the longitudinal direction of the arm portion. The first bearing portion includes a first track member, a second track member, and a plurality of first rolling elements. The first track member passes through the arm portion in a height direction of the rail, has an outer peripheral surface including a first raceway surface having a circular annular shape, and is fixed to the arm portion. The second track member has an inner peripheral surface including a second raceway surface having a circular annular shape being opposed to the first raceway surface, and has an outer peripheral surface including a first rail groove having a circular annular shape being in contact with the rail. The first rolling elements are arranged in a first rolling passage having a circular annular shape defined by the first raceway surface and the second raceway surface. The second bearing portion includes a third track member, a fourth track member, and a plurality of second rolling elements. The third track member passes through the arm portion in the height direction of the rail, has an outer peripheral surface including a third raceway surface having a circular annular shape, and is fixed to the arm portion. The fourth track member has an inner peripheral surface including a fourth raceway surface having a circular annular shape being opposed to the third raceway surface, and has an outer peripheral surface including a second rail groove having a circular annular shape being in contact with the rail. The second rolling elements are arranged in a second rolling passage having a circular annular shape defined by the third raceway surface and the fourth raceway surface. The straight-curved guide device further includes an elastic member, which is arranged across a space between the arm portion of the first swing portion and the arm portion of the second swing portion and is in a compressed state in which the elastic member is compressed in the longitudinal direction of the rail or in a stretched state in which the elastic member is stretched in the longitudinal direction of the rail.

In the straight-curved guide device, the elastic member, which is in the compressed state or the stretched state, is arranged across the space between the arm portion of the first swing portion and the arm portion of the second swing portion. Thus, a force in a direction to separate the first swing portion and the second swing portion from each other or a force in a direction to move the first swing portion and the second swing portion closer to each other acts on both of the swing portions. Thus, the first swing portion and the second swing portion pivot about their connecting portions to the frame in accordance with a width dimension of the rail, and thus can suppress an increase in a gap between the rail and the rail groove. Accordingly, with the straight-curved guide device, a decrease in guiding accuracy, which may be caused by the presence of a gap between the rail and the rail groove, can be suppressed.

In the straight-curved guide device, the elastic member may comprise a plurality of elastic members arranged side by side in the width direction of the rail. With the configuration described above, an increase in the gap between the rail and the rail groove can be more effectively suppressed.

In the straight-curved guide device, the arm portion of the first swing portion may have a first arm side surface, which faces the second swing portion and extends in the width direction of the rail. The arm portion of the second swing portion may have a second arm side surface, which faces the first swing portion and extends in the width direction of the rail. The arm portion of the first swing portion may have a first hole, which opens on the first arm side surface and has a depth in the longitudinal direction of the rail. The arm portion of the second swing portion may have a second hole, which opens on the second arm side surface and has a depth in the longitudinal direction of the rail. The elastic member may be arranged across the space between the first swing portion and the second swing portion so as to be received in the first hole and the second hole. With the configuration described above, the elastic member can be stably arranged across the space between the arm portion of the first swing portion and the arm portion of the second swing portion.

In the straight-curved guide device, the elastic member may be a spring.

### DESCRIPTION OF SPECIFIC EMBODIMENTS

Next, specific embodiments of a straight-curved guide device according to the present disclosure are described with reference to the drawings. In the drawings referred to below, the same or corresponding portions are denoted by the same reference symbols, and a description thereof is not repeated.

### First Embodiment

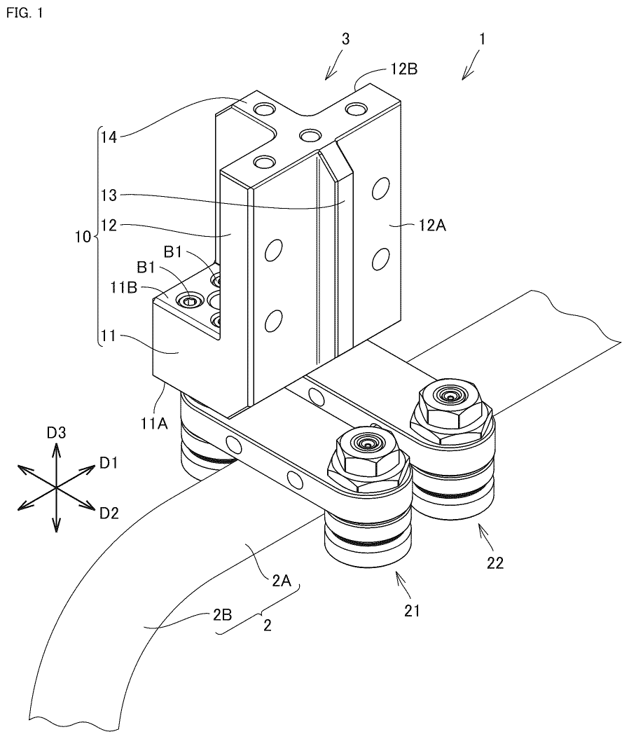

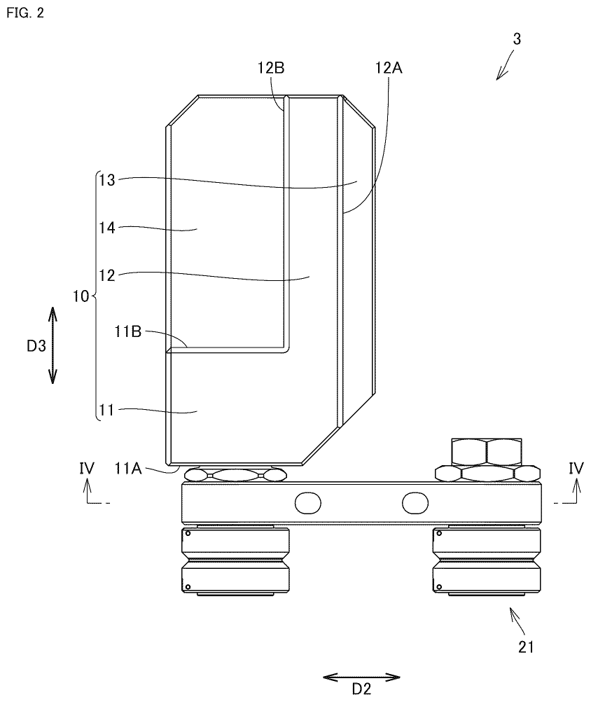

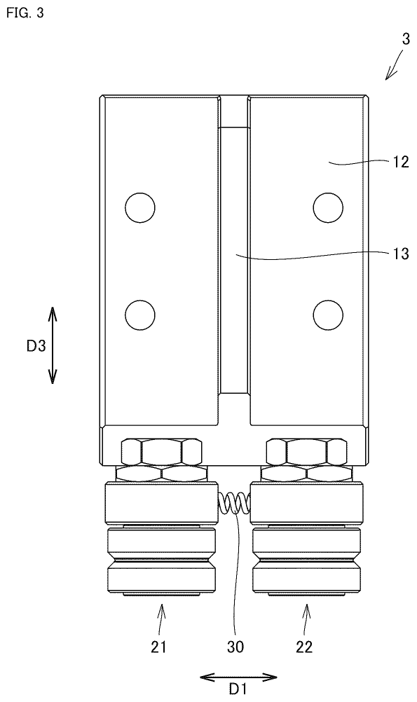

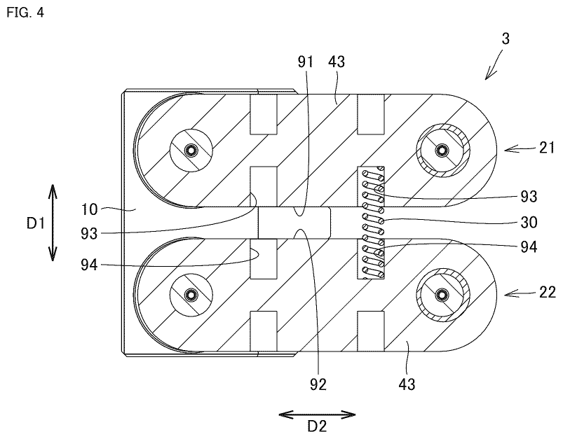

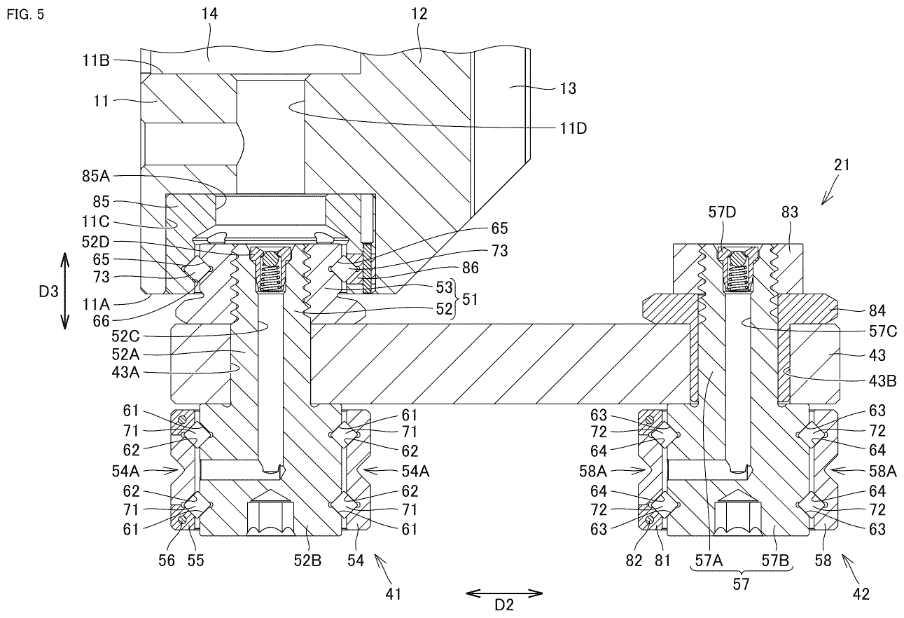

First, a configuration of a straight-curved guide device 1 according to a first embodiment is described with reference to FIG. 1 to FIG. 5. FIG. 1 is a perspective view for illustrating the configuration of the straight-curved guide device 1. FIG. 2 is a front view for illustrating a configuration of a movable element 3 of the straight-curved guide device 1. FIG. 3 is a side view for illustrating the configuration of the movable element 3 of the straight-curved guide device 1. FIG. 4 is a sectional view taken along the line IV-IV of FIG. 2. FIG. 5 is a sectional view of a first swing portion 21, taken in a height direction D3.

As illustrated in FIG. 1, the straight-curved guide device 1 includes a rail 2 and the movable element 3 as main components. The movable element 3 is movable on the rail 2. The rail 2 includes a straight part 2A and a curved part 2B connected to an end portion of the straight part 2A. The movable element 3 includes a frame 10, the first swing portion 21, and a second swing portion 22 as main components. Now, each of those components is described. A longitudinal direction D1, a width direction D2, and the height direction D3 of the rail 2 in this specification conform to those illustrated in FIG. 1 to FIG. 5.

As illustrated in FIG. 1, the frame 10 includes a first frame part 11 and a second frame part 12. The first frame part 11 is a part to which the first swing portion 21 and the second swing portion 22 are connected, and has a rectangular parallelepiped shape elongated in the longitudinal direction D1. The first frame part 11 has a first surface 11A (lower surface) and a second surface 11B (upper surface). The first surface 11A faces downward in the height direction D3. The second surface 11B faces in a direction opposite to the direction in which the first surface 11A faces.

The second frame part 12 has a rectangular parallelepiped shape elongated in the height direction D3. As illustrated in FIG. 1, the second frame part 12 extends perpendicularly to the first frame part 11 from an end portion of the first frame part 11 in the width direction D2. The second frame part 12 has a third surface 12A and a fourth surface 12B. The third surface 12A faces toward one side in the width direction D2. The fourth surface 12B faces in a direction opposite to the direction in which the third surface 12A faces. A first protruding portion 13 is formed on a substantially central area of the third surface 12A in the longitudinal direction D1. The first protruding portion 13 protrudes in the width direction D2 and extends in the height direction D3. Meanwhile, a second protruding portion 14 is formed on a substantially central area of the fourth surface 12B in the longitudinal direction D1. The second protrudin portion 14 protrudes in a direction of the width direction D2, which is opposite to the direction in which the first protruding portion 13 protrudes, and extends in the height direction D3.

The first swing portion 21 is a portion being in contact with the rail 2. As illustrated in FIG. 1, the first swing portion 21 is connected to the first frame part 11 on the first surface 11A side. More specifically, as illustrated in FIG. 5, an insertion hole 11C is formed in the first frame part 11. The insertion hole 11C opens toward the first surface 11A and has a depth in the height direction D3. The insertion hole 11C has a circular shape when viewed in the height direction D3. When a part (fifth track member 85 described later) of the first swing portion 21 is inserted into the insertion hole 11C and the bolts B1 (FIG. 1) are tightened, the first swing portion 21 is connected to the first frame part 11.

As illustrated in FIG. 5, an oil supply hole 11D is formed in the first frame part 11. The oil supply hole 11D communicates with the insertion hole 11C in the height direction D3. The oil supply hole 11D has a circular shape that is concentric with the insertion hole 11C and has a diameter smaller than that of the insertion hole 11C when viewed in the height direction D3. The oil supply hole 11D opens on the second surface 11B.

Similarly to the first swing portion 21, the second swing portion 22 (FIG. 1) is a portion being in contact with the rail 2. As illustrated in FIG. 1, the second swing portion 22 is spaced apart from the first swing portion 21 in the longitudinal direction D1 and is connected to the frame 10 (first frame part 11). The first swing portion 21 and the second swing portion 22 are configured to be pivotable about their connecting portions to the frame 10 in an imaginary plane including the longitudinal direction D1 and the width direction D2. The second swing portion 22 is connected to the frame 10 in a manner similar to that of the first swing portion 21. Thus, a description of a mounting structure for the second swing portion 22 to the frame 10 is omitted.

Next, a configuration of the first swing portion 21 is described in detail with reference to FIG. 5. As illustrated in FIG. 5, the first swing portion 21 includes an arm portion 43, a first bearing portion 41, and a second bearing portion 42. The arm portion 43 extends in the width direction D2. The first bearing portion 41 is arranged on one side (one end portion of the arm portion 43 in a longitudinal direction of the arm portion 43) when viewed from a center of the arm portion 43 in the longitudinal direction (width direction D2 of the rail 2). The second bearing portion 42 is arranged on another side (another end portion of the arm portion 43 in the longitudinal direction of the arm portion 43) when viewed from the center of the arm portion 43 in the longitudinal direction. As illustrated in FIG. 5, a first through hole 43A passing through the arm portion 43 in the height direction D3 is formed on the one side when viewed from the center of the arm portion 43 in the longitudinal direction. Meanwhile, a second through hole 43B passing through the arm portion 43 in the height direction D3 is formed on the another side when viewed from the center of the arm portion 43 in the longitudinal direction.

As illustrated in FIG. 5, the first bearing portion 41 includes a first track member 51, a second track member 54, and a fifth track member 85. The first track member 51 passes through the arm portion 43 in the height direction D3 and is fixed to the arm portion 43. The first track member 51 in this embodiment includes a first stud 52 and a first nut 53. The first stud 52 passes through the arm portion 43 (is inserted into the first through hole 43A) in the height direction D3. The first nut 53 has a circular annular shape and surrounds an outer peripheral surface of the first stud 52.

The first stud 52 includes a shaft portion 52A and a head portion 52B. The shaft portion 52A has a columnar shape and is inserted into the first through hole 43A. The head portion 52B has a diameter larger than that of the shaft portion 52A and is connected to a lower end portion of the shaft portion 52A. As illustrated in FIG. 5, an outer peripheral surface of the shaft portion 52A is in contact with an entire wall surface of the first through hole 43A in its circumferential direction. A first thread portion (male thread portion) is formed on an outer peripheral surface of a distal end portion (portion opposite to the head portion 52B) of the shaft portion 52A. A second thread portion (female thread portion) to be meshed with the first thread portion is formed on an entire inner peripheral surface of the first nut 53 in its circumferential direction.

As illustrated in FIG. 5, a first oil supply passage 52C is defined inside the first stud 52. The first oil supply passage 52C includes a first passage portion and a second passage portion. The first passage portion extends in the height direction D3 inside the shaft portion 52A. The second passage portion is connected to a lower end portion of the first passage portion and extends in a radial direction inside the head portion 52B. A first grease nipple 52D is arranged at an inlet of the first oil supply passage 52C. Lubricating oil can be supplied to a gap between the head portion 52B of the first stud 52 and the second track member 54 via the first oil supply passage 52C.

The first track member 51 has an outer peripheral surface including first raceway surfaces 61, each having a circular annular shape. As illustrated in FIG. 5, the first raceway surfaces 61 in this embodiment are formed in a plurality of rows (two rows) on an outer peripheral surface of the head portion 52B in such a manner as to be spaced apart from each other in the height direction D3. Each of the first raceway surfaces 61 in this embodiment has a V-like shape in cross section taken in the height direction D3. However, a sectional shape of the first raceway surface 61 is not limited to the V-like shape.

The first track member 51 has an outer peripheral surface including a fifth raceway surface 65 having a circular annular shape. As illustrated in FIG. 5, the fifth raceway surface 65 in this embodiment is formed on an entire outer peripheral surface of the first nut 53 in its circumferential direction. The fifth raceway surface 65 in this embodiment has a V-like shape in cross section taken in the height direction D3. However, a sectional shape of the fifth raceway surface 65 is not limited to the V-like shape. The first track member 51 is not limited to that including the first stud 52 and the first nut 53. For example, the first nut 53 may be omitted. In this case, the fifth raceway surface 65 may be formed on the outer peripheral surface of the shaft portion 52A of the first stud 52.

The second track member 54 is a circular annular member having an inner diameter larger than that of the first raceway surface 61. The second track member 54 has an inner peripheral surface including second raceway surfaces 62. Each of the second raceway surfaces 62 has a circular annular shape and is opposed to the first raceway surface 61 in a radial direction of the second track member 54. Each of the second raceway surfaces 62 in this embodiment has a V-like shape that opens in a direction opposite to the direction in which the first raceway surface 61 opens in cross section taken in the height direction D3. However, a sectional shape of the second raceway surface 62 is not limited to the V-like shape described above. As illustrated in FIG. 5, the second track member 54 has an outer peripheral surface including a first rail groove 54A formed therein. The first rail groove 54A has a circular annular shape and is in contact with the rail 2. The first rail groove 54A in this embodiment is a groove having a V-like shape in cross section taken in the height direction D3. However, the first rail groove 54A is not limited to that described above.

The fifth track member 85 (outer ring) is a circular annular member having an inner diameter larger than that of the fifth raceway surface 65. The fifth track member 85 has an inner peripheral surface including a sixth raceway surface 66. The sixth raceway surface 66 has a circular annular shape and is opposed to the fifth raceway surface 65 in a radial direction of the fifth track member 85. The sixth raceway surface 66 has a V-like shape that opens in a direction opposite to the direction in which the fifth raceway surface 65 opens in cross section taken in the height direction D3. However, a sectional shape of the fifth raceway surface 65 is not limited to the V-like shape described above. An annular hole 85A is formed in the fifth track member 85. The annular hole 85A overlaps the inlet of the first oil supply passage 52C in the height direction D3. The annular hole 85A overlaps the oil supply hole 11D in the height direction D3.

The fifth track member 85 is connected to the frame 10 (first frame part 11). Specifically, as illustrated in FIG. 5, the fifth track member 85 is inserted into the insertion hole 11C and is fixed to the first frame part 11 with the plurality of bolts B1 (FIG. 1). An outer peripheral surface of the fifth track member 85 is in contact with an entire wall surface of the insertion hole 11C in its circumferential direction. As illustrated in FIG. 5, a lower end surface of the fifth track member 85 in the height direction D3 is substantially flush with the first surface 11A of the frame 10. Meanwhile, a plurality of (for example, four) female thread holes (not shown) to be meshed with the bolts B1 (FIG. 1) are formed at intervals in a circumferential direction in an upper end surface of the fifth raceway member 85 in the height direction D3.

The first bearing portion 41 further includes a plurality of first rolling elements 71. The first rolling elements 71 in this embodiment are cylindrical rollers and are arranged in first rolling passages. Each of the first rolling passages has a circular annular shape and is defined by the first raceway surface 61 and the second raceway surface 62. Outer peripheral surfaces of the first rolling elements 71 are in contact with the first raceway surfaces 61 and the second raceway surfaces 62.

The first bearing portion 41 further includes a plurality of third rolling elements 73. The third rolling elements 73 in this embodiment are cylindrical rollers and are arranged in a third rolling passage. The third rolling passages has a circular annular shape and is defined by the fifth raceway surface 65 and the sixth raceway surface 66. Outer peripheral surfaces of the third rolling elements 73 are in contact with the fifth raceway surface 65 and the sixth raceway surface 66.

As illustrated in FIG. 5, an incorporation port for incorporating the third rolling elements 73 into the third rolling passage is formed in the fifth raceway member 85 in such a manner as to radially pass through a part of the fifth raceway member 85 in its circumferential direction. The incorporation port is closed with a first lid member 86. The first lid member 86 has a lid raceway surface (surface opposed to the fifth raceway surface 65 in the radial direction of the fifth raceway member 85) and a lid outer surface. The lid raceway surface is in contact with the third rolling elements 73. The lid outer surface is located on a side opposite to the lid raceway surface in the radial direction of the fifth raceway member 85. The lid raceway surface is substantially flush with the sixth raceway surface 66 and defines the third rolling passage in cooperation with the fifth raceway surface 65 and the sixth raceway surface 66. The lid outer surface is in contact with the wall surface of the insertion hole 11C under a state in which the fifth raceway member 85 has been inserted into the insertion hole 11C. The first lid member 83 may be fixed to the fifth raceway member 85 with a fixing member such as a pin.

As illustrated in FIG. 5, an incorporation port for incorporating the first rolling elements 71 into the first rolling passage is formed in the second track member 54. A second lid member 55 is arranged at the incorporation port. The second lid member 55 is fixed to the second track member 54 with a fixing member such as a pin 56.

The second bearing portion 42 includes a third track member 57, a fourth track member 58, a second nut 83, and an eccentric collar 84. The third track member 57 passes through the arm portion 43 in the height direction D3 and is fixed to the arm portion 43. As illustrated in FIG. 5, the third track member 57 includes a shaft portion 57A and a head portion 57B. The shaft portion 57A passes through the arm portion 43 (is inserted into the second through hole 43B) in the height direction D3. The head portion 57B has a diameter larger than that of the shaft portion 57A and is connected to a lower end of the shaft portion 57A. In the third track member 57, an outer peripheral surface of the head portion 57B includes third raceway surfaces 63, each having a circular annular shape. In this embodiment, the third raceway surfaces 63 form a plurality of (two) rows spaced apart from each other in the height direction D3. However, the third raceway surfaces 63 are not limited to those described above.

A third thread portion (male thread portion) is formed on an outer peripheral surface of a distal end portion (portion opposite to the head portion 57B) of the shaft portion 57A. A fourth thread portion (female thread portion) to be meshed with the third thread portion is formed on an entire inner peripheral surface of the second nut 83 in its circumferential direction. As illustrated in FIG. 5, a small-diameter portion of the eccentric collar 84 is inserted between the outer peripheral surface of the shaft portion 57A and a wall surface of the second through hole 43B. The small-diameter portion has a circular annular shape with a radial thickness changing in its circumferential direction.

A second oil supply passage 57C is defined inside the third track member 57. The second oil supply passage 57C includes a third passage portion and a second passage portion. The third passage portion extends in the height direction D3 inside the shaft portion 57A. The second passage portion is connected to a lower end portion of the third passage portion and extends in a radial direction inside the head portion 57B. A second grease nipple 57D is arranged at an inlet of the second oil supply passage 57C. Lubricating oil can be supplied to a gap between the head portion 57B and the fourth track member 58 via the second oil supply passage 57C.

The fourth track member 58 is a circular annular member having an inner diameter larger than that of the third raceway surface 63. The fourth track member 58 has an inner peripheral surface including fourth raceway surfaces 64. Each of the fourth raceway surfaces 64 has a circular annular shape and is opposed to the third raceway surface 63 in a radial direction of the fourth track member 58. Each of the fourth raceway surfaces 64 in this embodiment has a V-like shape that opens in a direction opposite to the direction in which the third raceway surface 63 opens in cross section taken in the height direction D3. However, a sectional shape of the fourth raceway surface 64 is not limited to the V-like shape described above. As illustrated in FIG. 5, the fourth track member 58 has an outer peripheral surface including a second rail groove 58A formed therein. The second rail groove 58A has a circular annular shape and is in contact with the rail 2. The second rail groove 58A in this embodiment is a groove having a V-like shape in cross section taken in the height direction D3. However, the second rail groove 58A is not limited to that described above.

The second bearing portion 42 further includes a plurality of second rolling elements 72. The second rolling elements 72 in this embodiment are cylindrical rollers and are arranged in second rolling passages. Each of the second rolling passages has a circular annular shape and is defined by the third raceway surface 63 and the fourth raceway surface 64. Outer peripheral surfaces of the second rolling elements 72 are in contact with the third raceway surface 63 and the fourth raceway surface 64.

As illustrated in FIG. 5, an incorporation port for incorporating the second rolling elements 72 into the second rolling passage is formed in the fourth track member 58. A third lid member 81 is arranged at the incorporation port. The third lid member 81 is fixed to the fourth track member 58 with a fixing member such as a pin 82.

The second swing portion 22 (FIG. 1) basically has a configuration similar to that of the first swing portion 21. Thus, a detailed description about the configuration of the second swing portion 22 is omitted.

As illustrated in FIG. 4, the arm portion 43 of the first swing portion 21 has a first arm side surface 91. The first arm side surface 91 faces the second swing portion 22 and extends in the width direction D2. The arm portion 43 of the second swing portion 22 has a second arm side surface 92 that is substantially parallel to the first arm side surface 91. As illustrated in FIG. 4, the second arm side surface 92 faces the first swing portion 21 (first arm side surface 91) and extends in the width direction D2.

As illustrated in FIG. 4, first holes 93 are formed in the arm portion 43 of the first swing portion 21. The first holes 93 are bottomed holes that open on the first arm side surface 91 and have a depth in the longitudinal direction D1. The first holes 93 are formed in an area of the arm portion 43, which does not overlap the frame 10 as viewed in cross section of FIG. 4. In this embodiment, a bottom portion of each of the first holes 93 is located closer to the second swing portion 22 than a center of the arm portion 43 in the longitudinal direction D1. However, a position of the bottom portion of each of the first holes 93 is not limited to that described above. The first holes 93 in this embodiment each have an ellipsoidal shape elongated in the longitudinal direction D1 when viewed in the longitudinal direction D1. However, a shape of the first hole 93 is not limited to that described above.

As illustrated in FIG. 4, second holes 94 are formed in the arm portion 43 of the second swing portion 22. The second holes 94 are bottomed holes that open on the second arm side surface 92 and have a depth in the longitudinal direction D1. The second holes 94 are formed in an area of the arm portion 43, which does not overlap the frame 10 as viewed in cross section of FIG. 4. The second holes 94 are opposed to the first holes 93 in the longitudinal direction D1. In other words, the first hole 93 and the second hole 94 are positioned on an imaginary straight line extending in the longitudinal direction D1. In this embodiment, the second holes 94 have substantially the same depth as the depth of the first holes 93. However, the depth of the second hole 94 is not limited to that described above.

As illustrated in FIG. 3 and FIG. 4, the movable element 3 further includes an elastic member 30. The elastic member 30 in this embodiment is a coil spring and is arranged across a space between the arm portion 43 of the first swing portion 21 and the arm portion 43 of the second swing portion 22 (FIG. 4). More specifically, the elastic member 30 in this embodiment is in a compressed state in which the elastic member 30 is compressed in the longitudinal direction D1, and is arranged across the space between the first swing portion 21 and the second swing portion 22 so as to be received in the first hole 93 and the second hole 94. That is, the elastic member 30 has a shape extending in the longitudinal direction D1. One end of the elastic member 30 in the longitudinal direction D1 is received in the first hole 93, and another end of the elastic member 30 in the longitudinal direction D1 is received in the second hole 94. Thus, a restoring force of the elastic member 30, which is a compression spring, acts on the bottom portions of the first hole 93 and the second hole 94, and hence a force in a direction to separate the first swing portion 21 and the second swing portion 22 from each other is applied by the elastic member 30 to the first swing portion 21 and the second swing portion 22.

As described above, in the straight-curved guide device 1 according to this embodiment, the elastic member 30, which is in the compressed state, is arranged across the space between the arm portion 43 of the first swing portion 21 and the arm portion 43 of the second swing portion 22. Thus, a force in a direction to separate the first swing portion 21 and the second swing portion 22 from each other acts on both of the swing portions. Thus, the first swing portion 21 and the second swing portion 22 pivot about their connecting portions to the frame 10 in accordance with a width dimension of the rail 2, and thus can suppress an increase in a gap between the rail 2 and the rail groove (first rail groove 54A, second rail groove 58A). Accordingly, with the straight-curved guide device 1 according to this embodiment, a decrease in guiding accuracy, which may be caused by the presence of a gap between the rail 2 and the rail groove, can be suppressed.

### Second Embodiment

Next, a straight-curved guide device according to a second embodiment is described. The second embodiment is basically similar to the first embodiment described above. However, the second embodiment differs from the first embodiment in that an elastic member 30 is a tension spring. Only differences from the first embodiment are described below.

The elastic member 30 in the second embodiment is arranged across a space between an arm portion 43 of a first swing portion 21 and an arm portion 43 of a second swing portion 22 while being in a stretched state in which the elastic member 30 is stretched in the longitudinal direction D1. One end of the elastic member 30 in the longitudinal direction D1 is connected to a bottom portion of a first hole 93. Meanwhile, another end of the elastic member 30 in the longitudinal direction D1 is connected to a bottom portion of a second hole 94.

In the second embodiment, a tension spring is used as the elastic member 30. Thus, a force in a direction to move the first swing portion 21 and the second swing portion 22 closer to each other acts on both of the swing portions. Thus, similarly to the first embodiment, the first swing portion 21 and the second swing portion 22 pivot about their connecting portions to the frame 10 in accordance with a width dimension of the rail 2, and thus can suppress an increase in a gap between the rail 2 and the rail groove.

### Third Embodiment

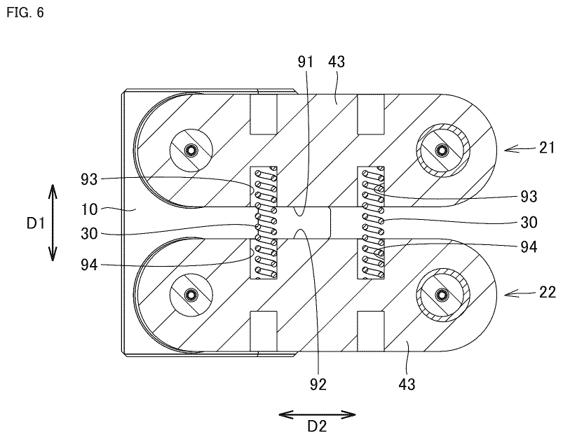

Next, a straight-curved guide device according to a third embodiment is described with reference to FIG. 6. The third embodiment is basically similar to the first embodiment or the second embodiment. However, the third embodiment differs from the first embodiment or the second embodiment in that a plurality of elastic members 30 are provided. Only differences from the first embodiment and the second embodiment are described below.

As illustrated in FIG. 6, a plurality of (two in this embodiment) first holes 93 are formed apart from each other in the width direction D2. Similarly, a plurality of (two in this embodiment) second holes 94 are formed apart from each other in the width direction D2.

The plurality of elastic members 30 are compression springs or tension springs and are arranged side by side in the width direction D2. As illustrated in FIG. 6, the elastic members 30 are received in the plurality of first holes 93 and the plurality of second holes 94. Thus, a force to separate the first swing portion 21 and the second swing portion 22 from each other or a force to move the first swing portion 21 and the second swing portion 22 closer to each other can be further increased.

### OTHER EMBODIMENTS

Now, other embodiments are described.

In the embodiments described above, the first hole 93 and the second hole 94 formed in the arm portions 43 have been described as an example. However, the first hole 93 and the second hole 94 are not limited to those described above. One or both of the first hole 93 and the second hole 94 may be omitted.

In the embodiments described above, a coil spring used as the elastic member has been described as an example. However, the elastic member is not limited to a coil spring. As the elastic member, for example, a leaf spring or a torsion spring can be used. Further, the elastic member is not limited to a spring, and may be a member made of, for example, a rubber.

In the embodiments described above, the first swing portion 21 and the second swing portion 22 that are connected to the frame 10 at their ends in the width direction D2 have been described as an example. However, the connection of the first swing portion 21 and the second swing portion 22 is not limited to that described above. Central areas of the arm portions of the first swing portion and the second swing portion in the longitudinal direction may be connected to the frame.

It is to be understood that each of the embodiments disclosed herein is merely an example in all aspects and in no way intended to limit the present disclosure. The scope of the present invention is defined by the appended claims and not by the above description, and it is intended that the present invention encompasses all modifications made within the scope and spirit equivalent to those of the appended claims.

### REFERENCE SIGNS LIST

1 straight-curved guide device, 2 rail, 2A straight part, 2B curved part, 3 movable element, 10 frame, 11 first frame part, 11A first surface, 11B second surface, 11C insertion hole, 11D oil supply hole, 12 second frame part, 12A third surface, 12B fourth surface, 13 first protruding portion, 14 second protruding portion, 21 first swing portion, 22 second swing portion, 30 elastic member, 41 first bearing portion, 42 second bearing portion, 43 arm portion, 43A first through hole, 43B second through hole, 51 first track member, 52 first stud, 52A, 57A shaft portion, 52B, 57B head portion, 52C first oil supply passage, 52D first grease nipple, 53 first nut, 54 second track member, 54A first rail groove, 55 second lid member, 56, 82 pin, 57 third track member, 57C second oil supply passage, 57D second grease nipple, 58 fourth track member, 58A second rail groove, 61 first raceway surface, 62 second raceway surface, 63 third raceway surface, 64 fourth raceway surface, 65 fifth raceway surface, 66 sixth raceway surface, 71 first rolling element, 72 second rolling element, 73 third rolling element, 81 third lid member, 83 second nut, 84 eccentric collar, 85 fifth track member, 85A annular hole, 86 first lid member, 91 first arm side surface, 92 second arm side surface, 93 first hole, 94 second hole, B1 bolt, D1 longitudinal direction, D2 width direction, D3 height direction

1. A straight-curved guide device, comprising:
a rail including a straight part and a curved part; and
a movable element being movable on the rail, the movable element including:
a frame;
a first swing portion, which is connected to the frame and is in contact with the rail; and
a second swing portion, which is connected to the frame in such a manner as to be spaced apart from the first swing portion in a longitudinal direction of the rail, and is in contact with the rail,
wherein the first swing portion and the second portion are configured to be pivotable about connecting portions to the frame in a plane including the longitudinal direction of the rail and a width direction of the rail,
wherein each of the first swing portion and the second swing portion includes:
an arm portion extending in the width direction of the rail;
a first bearing portion arranged on one side of the arm portion when viewed from a center of the arm portion in a longitudinal direction of the arm portion; and
a second bearing portion arranged on another side of the arm portion when viewed from the center of the arm portion in the longitudinal direction of the arm portion,
wherein the first bearing portion includes:
a first track member, which passes through the arm portion in a height direction of the rail, has an outer peripheral surface including a first raceway surface having a circular annular shape, and is fixed to the arm portion;
a second track member, which has an inner peripheral surface including a second raceway surface having a circular annular shape being opposed to the first raceway surface, and has an outer peripheral surface including a first rail groove having a circular annular shape being in contact with the rail; and
a plurality of first rolling elements arranged in a first rolling passage having a circular annular shape defined by the first raceway surface and the second raceway surface,
wherein the second bearing portion includes:
a third track member, which passes through the arm portion in the height direction of the rail, has an outer peripheral surface including a third raceway surface having a circular annular shape, and is fixed to the arm portion;
a fourth track member, which has an inner peripheral surface including a fourth raceway surface having a circular annular shape being opposed to the third raceway surface, and has an outer peripheral surface including a second rail groove having a circular annular shape being in contact with the rail; and
a plurality of second rolling elements arranged in a second rolling passage having a circular annular shape defined by the third raceway surface and the fourth raceway surface, and
wherein the straight-curved guide device further comprises an elastic member, which is arranged across a space between the arm portion of the first swing portion and the arm portion of the second swing portion and is in a compressed state in which the elastic member is compressed in the longitudinal direction of the rail or in a stretched state in which the elastic member is stretched in the longitudinal direction of the rail.

2. The straight-curved guide device according to claim 1, wherein the elastic member comprises a plurality of elastic members arranged side by side in the width direction of the rail.

3. The straight-curved guide device according to claim 1,
wherein the arm portion of the first swing portion has a first arm side surface, which faces the second swing portion and extends in the width direction of the rail,
wherein the arm portion of the second swing portion has a second arm side surface, which faces the first swing portion and extends in the width direction of the rail,
wherein the arm portion of the first swing portion has a first hole, which opens on the first arm side surface and has a depth in the longitudinal direction of the rail,
wherein the arm portion of the second swing portion has a second hole, which opens on the second arm side surface and has a depth in the longitudinal direction of the rail, and
wherein the elastic member is arranged across the space between the first swing portion and the second swing portion so as to be received in the first hole and the second hole.

4. The straight-curved guide device according to claim 1, wherein the elastic member is a spring.

5. The straight-curved guide device according to claim 2,
wherein the arm portion of the first swing portion has a first arm side surface, which faces the second swing portion and extends in the width direction of the rail,
wherein the arm portion of the second swing portion has a second arm side surface, which faces the first swing portion and extends in the width direction of the rail,
wherein the arm portion of the first swing portion has a first hole, which opens on the first arm side surface and has a depth in the longitudinal direction of the rail,
wherein the arm portion of the second swing portion has a second hole, which opens on the second arm side surface and has a depth in the longitudinal direction of the rail, and
wherein the elastic member is arranged across the space between the first swing portion and the second swing portion so as to be received in the first hole and the second hole.

6. The straight-curved guide device according to claim 2, wherein the elastic member is a spring.
